(19) United States
(12) Patent Application Publication
(10) Pub. No.: US 2018/0216338 A1
(43) Pub. Date: Aug. 2, 2018

(54) Manufacturing Method for an Anchoring Rail and Anchoring Rail

(71) Applicant: Hilti Aktiengesellschaft, Schaan (LI)

(72) Inventors: Horst STROISSNIGG, Puergen (DE); Juergen KEIM, Kaufering (DE); Damian PIONTEK, Untermeitingen (DE); Robert KRAFT, Waldbronn (DE)

(73) Assignee: Hilti Aktiengesellschaft, Schaan (LI)

(21) Appl. No.: 15/747,948

(22) PCT Filed: Jul. 26, 2016
(86) PCT No.: PCT/EP2016/067726

§ 371 Date: Jan. 26, 2018

(30) Foreign Application Priority Data
Jul. 29, 2015 (EP) 15178961.7

(51) Int. Cl. E04B 1/41; B23K 26/24; B23K 26/244; B23K 33/00

(52) U.S. Cl. CPC E04B 1/4107; B23K 33/004; B23K 26/244; B23K 26/24

(57) ABSTRACT

A method for producing an anchoring rail with a rail body and an anchoring body includes arranging a fastening body, which has an opening, in the interior of the rail body. The anchoring body is passed through a passage opening in the rail body and the anchoring body is connected in a cohesive manner to the fastening body and to the rail body at the same time in one joining process.

This application claims the priority of International Application No. PCT/EP2016/067726, filed Jul. 26, 2016, which claims priority under 35 U.S.C. § 119 from German Patent Application No. 151789613, filed Jul. 26, 2015, the disclosures of which are expressly incorporated by reference herein.

### BACKGROUND AND SUMMARY OF THE INVENTION

The invention relates to a method for producing an anchoring rail with a rail body and with anchoring bodies, which are fastened to the rail body. The invention further relates to an anchoring rail with a rail body and with anchoring bodies, which are fastened to the rail body.

DE 102008036523 A1 describes an anchoring rail with anchoring bodies welded on the outside, wherein special materials are provided for rail and anchoring body. Another rail with externally welded anchoring bodies is shown in US 2009064626 A1. According to DE 19642331 C2, anchoring bodies are fastened to the outside of the rail in a friction welding process. According to EP0724678 A1, anchoring bodies are fastened to the outside of the rail in a spot welding process.

DE 4411791 A1 relates to a method for producing anchor bolts provided with anchoring rails, in which an anchor nut having an internal thread is fastened by means of electrical resistance welding to the rail body and then an anchoring body is screwed into the anchor nut.

US 2014318072 A1 shows an anchoring body with an anchor foot rail widened on the rail inner side and also shows an anchoring body welded to the outside of the rail body.

EP 1067248 B1 describes an anchoring rail in which the anchoring body has an external thread and an enlarged anchor foot in the rail interior, wherein the anchoring body is secured to the anchoring rail by means of nuts screwed onto the external thread. According to US 2010170185 A1, rivets are fastened to the rail body of an anchoring rail, into which the anchoring bodies are screwed, wherein a screw lock can also be used. US 2010146904 A1 teaches to provide passages on the rail back directed into the interior of the rail body, wherein anchoring bodies are screwed into the passages.

DE 19907475 C1 describes a method for producing an anchoring rail, in which an anchoring body is inserted from the inside of a rail body through a passage opening in the rail body, the anchor foot being brought into contact with the rail body inside the rail body, and at the outside of the rail a cutting tool is moved relative to the anchor foot in the direction of the anchor foot, and in the course of the movement the armature shaft material is stripped off, so that on the outside of the rail body a stripping collar is formed.

EP 0758039 B1 discloses a method for producing an anchoring rail, in which an anchoring body is passed through an opening in the rail body and subsequently the section of the anchoring body located within the rail body is deformed by compression and the anchoring body is thereby fixed. Other anchoring bodies with compressed geometry are shown in U.S. Pat. No. 5,743,062 A.

EP 0400588 A1 relates to a compression anchor for anchoring rails with a head, a shaft and a foot, which serves for the compression connection with the anchoring rail back, wherein the head and the shank are made of general structural steel and the base is made of stainless steel, and the foot is connected with the shank by welding.

The U.S. Pat. No. 6,682,253 B describes a fastening rail, which consists of a profile element and a cross-sectional larger hollow profile, wherein the profile element is connected with the hollow profile by laser beam welding.

The object of the invention is to provide a method for producing an anchoring rail, with which connection between the anchoring bodies and the rail body can be obtained in a particularly simple and economical way, such that it is particularly reliable, and especially resistant to both tension and pressure, and to provide a corresponding anchoring rail.

In a production method according to the invention, it is provided that:

a fastening body, which is provided with an opening, is arranged in the interior of the rail body,

an anchoring body is passed through a through hole provided in the rail body,

the anchoring body is arranged in the opening of the fastening body, and

the anchoring body is at the same time cohesively connected with the fastening body and with the rail body in a material joining process.

A basic idea of the invention can be seen in providing a fastening body into the interior of the rail body, in which the anchoring body is introduced with its anchor foot, and to cohesively join the anchoring body with the fastening body with simultaneous connection to the rail body. Therefore, simultaneous cohesive material connection of the fastening body, anchoring body and rail body is provided. In particular, a common weld can be provided, which adjoins the fastening body, the anchoring body and the rail body, which can be achieved for example by laser beam deep welding. The invention has recognized that in this way a connection between the anchoring body and the rail body can be obtained, which on the one hand can absorb comparatively high tensile forces, but on the other hand also comparatively high back pressure forces directed into the rail interior. Among other things, the high tensile forces can be based on the fact that the fastening body can form an undercut body which fixes the anchoring body in the rail body in a form-fitting manner. Among other things, the high return forces can be due to the joint connection which, according to the invention, is realized in a particularly simple manner without an additional process step. In comparison with a method in which the anchoring bodies are welded in a butt joint on the outside of the rail body, the same tensile loads can be obtained with smaller anchor cross-sectional areas and/or smaller material thicknesses of the anchoring rail and/or lower material strength of the loaded parts in the method according to the invention. In addition, the requirements for the precision of the positioning of the anchoring body relative to the rail body and the process variations can be comparatively low. For these reasons, but also due to the relatively small number of process steps, a particularly simple and economical production process is provided.

The rail body expediently has an at least approximately C-shaped cross section, which can also be combined with a V-shaped rail back. The rail body is preferably provided with a longitudinal slot, adjacent to two tabs on longitudinal side. These tabs can be engaged from behind by a hammer head screw extending through the longitudinal slot into the interior of the rail, whereby the hammer head screw is fixed to the rail body. An anchoring rail produced using the method according to the invention and/or produced according to the invention can be east in concrete in such a way that the longitudinal slot is accessible from the outside.

The anchoring body can act in particular as a tie rod and/or is preferably formed in the shape of a bolt. The anchoring body preferably has an anchor foot, which is arranged in the interior of the rail body in the fastening body, an anchor head arranged opposite to the anchor foot, which is arranged outside the rail body, and an anchor shaft running between anchor base and anchor head, wherein the anchor head, for the targeted introduction of tensile force into the concrete, may preferably be of a larger cross-section than the anchor shaft. The opening of the fastening body and the passage opening of the rail body preferably have at least approximately the same cross-section. Preferably, the cross-sectional area of the opening of the fastening body and/or the cross-sectional area of the passage opening of the rail body correspond to the cross-sectional area of the anchor foot. Which may facilitate positioning. In particular, the cross-sectional area of the anchor foot, the cross-sectional area of the opening of the fastening body and/or the cross-sectional area of the passage opening of the rail body may be circular. For example, the anchoring body can be designed as a cylindrical head bolt. The rail body, the fastening body and/or the anchoring body are preferably made of a metal material. The passage opening and thus the anchoring body can be arranged in particular on the rail back. The fastening body arranged in the interior of the rail body may also have an extension or a plurality of extensions that protrudes or protrude outward from the interior of the rail body.

The anchoring rail obtained in the method according to the invention has a plurality of anchoring bodies. The manufacturing method according to the invention can be used in one of the anchoring bodies of the anchoring rail, in a plurality, but not all anchoring bodies of the anchoring rail, or preferably in all anchoring bodies of the anchoring rail, which can make the process even more economical.

Preferably, the passage opening of the rail body is created before the fastening body is introduced into the interior of the rail body. As a result, the process control can be simplified further. For example, the passage opening of the rail body can be produced by punching. The production of the passage opening of the rail body can be done prior to the start of the method according to the invention, but in principle also in the course of the method according to the invention. The anchoring body is expediently arranged in the opening of the fastening body while the fastening body is located in the interior of the rail body.

Expediently, the fastening body rests on the rail body during the joining process, in particular on the inside of the rail body, and/or the anchoring body is arranged in the opening of the fastening body during the joining process.

The joining process is particularly preferably a welding process, preferably a laser beam welding process, in particular a laser beam deep welding process. Hereby, the simultaneous cohesive bonding can be carried out in a particularly simple manner. In particular, it can be provided that in the laser beam welding process, a laser beam is beamed through the interior of the rail body. According to this embodiment, the welding process takes place from the inside of the rail body, which enables particularly reliable welded connections in a particularly simple manner. Conveniently, it can be provided that the laser beam used in the laser beam welding process enters through the longitudinal slot of the rail body into the interior of the rail body. This can simplify the process even further, since the laser beam is guided through an already existing opening in the interior of the rail body. It is particularly preferred that the laser beam used in the laser beam welding process be focused on the joint between anchoring body and fastening body, wherein a focal spot displacement both in the height and in the direction of one of the joint partners, i.e., the anchoring bodies or fastening bodies, may be useful for process engineering reasons.

The fixing body and/or the anchoring body is directed. As a result, the quality of the welded connection can be further improved.

According to a further preferred variant of the method, it can be provided that the opening of the fastening body is arranged congruent with the passage opening of the rail body, and that the anchoring body is guided at the same time through the passage opening of the rail body and introduced into the opening of the fastening body following the congruent arrangement. Following this, the joining process is carried out. According to this variant, the anchoring body is introduced before the joining process in one pull both into the passage opening of the rail body and in the opening of the fastening body. The axial positioning of the anchoring body in the fastening body can be done flush with the fastening body, stopping short of the fastening body, or projecting beyond the fastening body.

In an alternative variant of the method, it can be provided that the fastening body is plugged onto the through-guided anchoring body after passing of the anchoring body through the passage opening of the rail body, preferably in the interior of the rail body. Following this, the joining process is carried out. According to this variant, the passage opening of the rail body and the opening of the fastening body when passing the anchoring body through the passage opening of the rail body need not be congruent. The fastening body may preferably be introduced into the interior of the rail body only after the anchoring body has been passed through the passage opening of the rail body. In principle, however, it can also be provided that the fastening body is already in the interior of the rail when the anchoring body is passed through the passage opening of the rail body. The axial positioning of the anchoring body in the fastening body can be done flush with the fastening body, stopping short of the fastening body, or projecting beyond the fastening body.

The opening of the fastening body could be a blind hole. However, it is particularly preferred that the opening of the fastening body be a passage opening, that is to say an opening which completely penetrates the fastening body, in particular, the fastening body may be a ring. As a result, the process control can be further simplified and the load bearing can be further improved in a particularly simple manner.

A further preferred variant consists in that the fastening body, at least when the passage opening of the rail body and the opening of the fastening body are congruent, is larger in cross-section than the passage opening of the rail body. In particular, the fastening body can thus be so large that it does not fit through the passage opening of the rail body. As a result, an even more reliable connection between the anchoring body and rail body can be obtained in a particularly simple way. The fastening body suitably has a shape corresponding to the inside of the rail body in the area of the passage opening for a large contact area with the rail body. Preferably, the passage opening may be provided in the rail back, so that the fastening body suitably has a shape which corresponds to the inside of the rail back.

An anchoring rail according to the invention is characterized in that at least one of the anchoring bodies is connected in a materially bonded manner both to a fastening body arranged in the interior of the rail body and to the rail body, in particular directly cohesively connected thereto, preferably welded. In particular, the anchoring rail may have a common weld seam, which adjoins the at least one anchoring body, the fastening body and the rail body. The anchoring rail can in particular be produced using a method according to the invention. The described type of fastening can be provided in one of the anchoring bodies of the anchoring rail, in a plurality, but not all anchoring bodies of the anchoring rail, or preferably in all anchoring bodies of the anchoring rail.

Features which are discussed in connection with the production method according to the invention can also be used in the anchoring rail according to the invention, and conversely, features which are discussed in connection with the anchoring rail according to the invention can also be used in the production method according to the invention.

The invention will be explained in more detail below with reference to preferred embodiments, which are shown schematically in the accompanying Figures, wherein individual features of the embodiments shown below can be realized in the context of the invention, in principle, individually or in any combination.

### BRIEF DESCRIPTION OF THE DRAWINGS

FIG. 1 shows a sectional perspective view of an anchoring rail produced in accordance with a method according to the invention;

FIG. 2 is a side view of the anchoring rail of FIG. 1;

FIG. 3 is a front view of the anchoring rail of FIG. 1 with an additional hammer head screw;

FIGS. 4 to 8 illustrate successive process stages in the production of an anchoring rail according to FIGS. 1 to 3 in a first process variant, wherein a higher number of the Figure means a later stage of the process; and

FIGS. 9 to 13 illustrate successive stages in the production of an anchoring rail according to FIGS. 1 to 3 in a second variant of the method, wherein a higher number of the Figure means a later stage of the process.

### DETAILED DESCRIPTION OF THE DRAWINGS

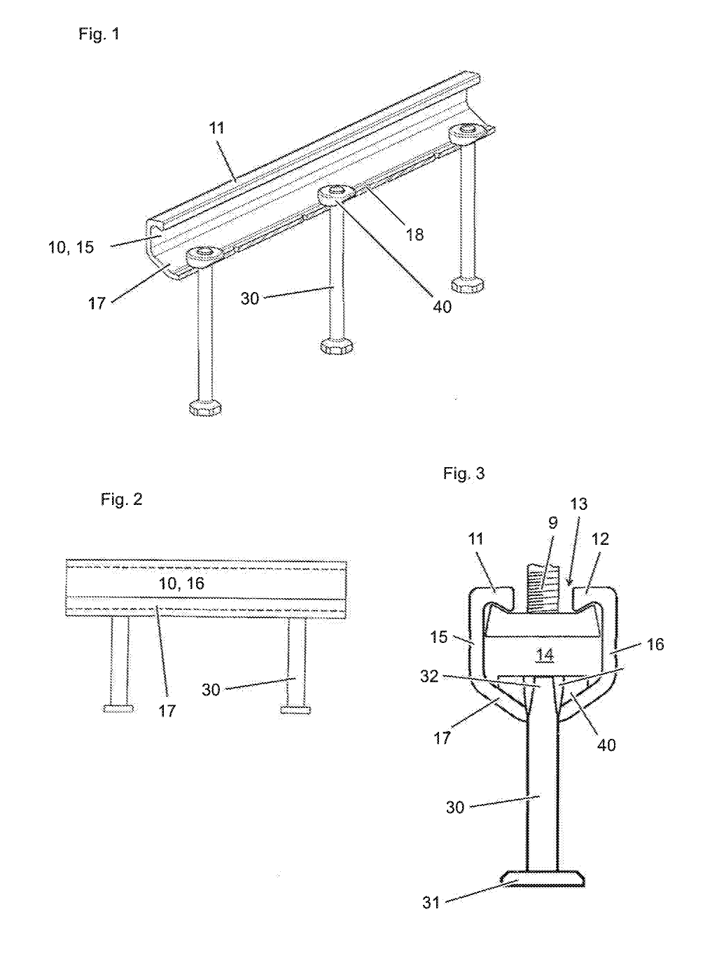

FIGS. 1 to 3 show an anchoring rail according to the invention, which can be manufactured using a method according to the invention.

The anchoring rail has a rail body 10 which is approximately C-shaped in cross-section and to which a plurality of anchoring bodies 30 are fastened at a distance from one another. The rail body 10 has two side walls 15 and 16, preferably parallel to each other, which are connected by a rail back 17, wherein the rail back 17 is executed in the present case as V-shaped in cross-section. The anchoring bodies 30 are connected to the rail back 17 of the rail body 10. On the first side wall 15, a first tab 11 protrudes toward the second side wall 16. Accordingly, on the second side wall 16, a second tab 12 protrudes toward the first side wall 15. Between the two webs 11 and 12, a longitudinal slot 13 is formed. Through this longitudinal slot 13, the head of a hammer head screw 9 can be inserted into the interior 14 of the rail body 10, wherein the hammer head screw 9 can then be positively fixed by rotation about its longitudinal axis on the two tabs 11 and 12, which each form an undercut. This fixed state of the hammer head screw 9 is shown in FIG. 3.

On the rail back 17, i.e., on the side of the rail body 10 which is opposite the longitudinal slot 13, a plurality of nail holes 18 are provided in the rail body 10, which serve to set the anchoring rail before setting in concrete on a formwork.

As will be explained in detail below, at least one part of the anchoring bodies 30, preferably all anchoring bodies 30, are each secured to the rail by means of an annular fastening body 40. The fastening bodies 40 are located in the interior 14 of the rail body 10, and are connected to the rail body 10, in particular with its rail back 17, as well as to the respective anchoring body 30 cohesively, in particular welded. In particular, the anchoring rail has common weld seams 111, preferably laser beam weld seams, which adjoin the respective anchoring body 30, the respective fastening body 40 and the rail body 10.

As FIG. 3 shows in particular, the anchoring bodies 30 each have an anchor head 31 arranged outside the rail body 10 and an anchor foot 32 arranged in the interior 14 of the rail body 10. The anchor head 31 preferably forms a local cross-sectional widening. The cohesive connection of the anchoring body 30 with the fastening body 40 is formed on the anchor foot 32.

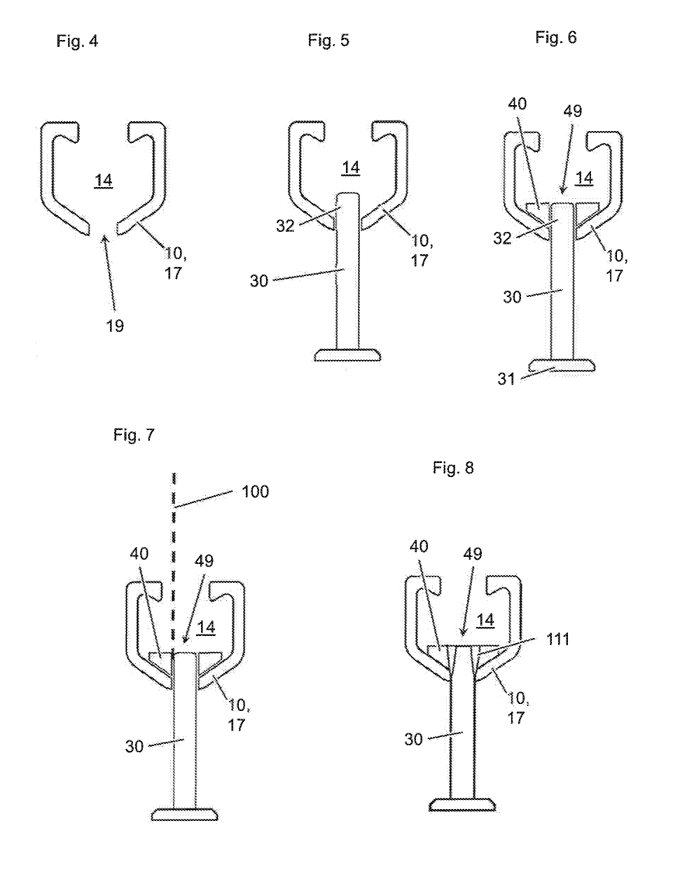

FIGS. 4 to 8 show a sequence of stages in a first embodiment of a manufacturing method for an anchoring rail according to FIGS. 1 to 3.

In the method variant of FIGS. 4 to 8, as shown in FIG. 4, the rail body 10 is initially provided with, at least one passage opening 19 in the rail back 17. The passage opening 19 extends from the outside of the rail body 10 into the interior 14 of the rail body 10 and is preferably circular.

Then, as shown in FIG. 5, an anchoring body 30 is passed through the passage opening 19 of the rail body 10. The anchor foot 32 of the anchoring body 30 is then located in the interior 14 of the rail body 10 and the anchor head 31 of the anchoring body 30 outside of the rail body 10. In particular, the anchoring body 30 can be inserted from the outside into the rail body 10, that is, the anchoring body 30 is in particular with the anchor foot 32 ahead inserted into the passage opening 19 of the rail body 10.

In the next step, which is shown in FIG. 6, an annular fastening body 40 in the interior 14 of the rail body 10 is attached to the anchoring body 30, namely its anchor foot 32, wherein the anchoring body 30, namely its anchor foot 32, is arranged in an opening 49 of the fastening body 40. Furthermore, the fixing body 40 is brought into contact with the rail body 10, preferably its rail back 17.

Then, as shown in FIG. 7, a laser beam welding process is performed, in which the anchoring body 30 is integrally connected to the fastening body 40 and the rail body 10. As FIG. 7 shows, a laser beam 100 is preferably directed through the rail body 10 onto the fastening body 40 and/or the anchoring body 30.

The finished anchoring rail is shown in FIG. 8. As can be seen there, the rail body 10, the fastening body 40 and the anchoring body 30 are connected by a common weld seam 111.

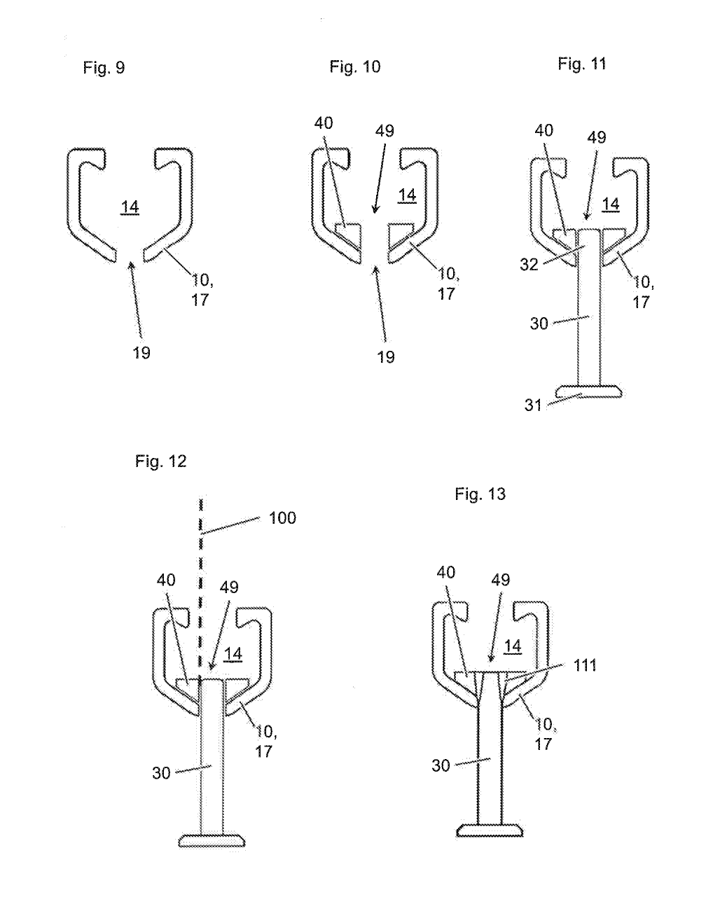

FIGS. 9 to 13 show a sequence of stages in a second embodiment of a production method for an anchoring rail according to FIGS. 1 to 3.

In the method variant of FIGS. 9 to 13, as shown in FIG. 9, the rail body 10 is initially provided with at least one passage opening 19 in the rail back 17. The passage opening 19 extends from the outside of the rail body 10 into the interior 14 of the rail body 10 and is preferably circular.

Then, as shown in FIG. 10, an annular fastening body 40 is provided with an opening 49 and arranged in the interior 14 of the rail body 10, that the opening 49 of the fastening body 40 is aligned with the through hole 19 of the rail body 10 and is open to through hole 19 of the rail body 10.

In the next step, which is shown in FIG. 11, an anchoring body 30 is passed from the outside through the passage opening 19 of the rail body 10 and thereby, in particular with its anchor foot 32, inserted into the opening 49 of the fastening body 40. Even before this step, or afterwards, the fastening body 40 is brought into contact with the rail back 17.

Then, as shown in FIG. 12, a laser beam welding process is carried out, in which the anchoring body 30 is adhesively bonded to the fastening body 40 and the rail body 10. As FIG. 12 shows, a laser beam 100 is preferably directed through the rail body 10 onto the fastening body 40 and/or the anchoring body 30.

The finished anchoring rail is shown in FIG. 13. As can be seen there, the rail body 10, the fastening body 40 and the anchoring body 30 are connected by a common weld seam 111.

Both in the method variant of FIGS. 4 to 8 and in the method variant of FIGS. 9 to 13, the opening 49 of the fastening body 40 is shown as a passage opening. In principle, however, it could also be designed as a blind hole, which is open towards the anchoring body 30.

1.-10. (canceled)

11. A method for producing an anchoring rail with a rail body and with an anchoring body, comprising the steps of:
disposing a fastening body that defines an opening in an interior of the rail body;
passing the anchoring body through a passage opening defined by the rail body;
disposing the anchoring body in the opening of the fastening body; and
cohesively connecting the anchoring body at a same time with the fastening body and with the rail body in a material joining process.

12. The method according to claim 11, wherein the material joining process is a laser welding process.

13. The method according to claim 12, wherein a laser beam is beamed through the interior of the rail body in the laser welding process.

14. The method according to claim 11, wherein the opening of the fastening body is disposed congruently with the passage opening of the rail body and wherein the anchoring body, subsequent to the congruent disposing, simultaneously passes through the passage opening of the rail body and is inserted into the opening of the fastening body.

15. The method according to claim 11, wherein subsequent to the passing of the anchoring body through the passage opening of the rail body the fastening body is plugged on to the anchoring body.

16. The method according to claim 11, wherein the opening of the fastening body is a passage opening.

17. The method according to claim 11, wherein the fastening body is larger in cross-section than the passage opening of the rail body.

18. An anchoring rail, comprising:
a rail body;
an anchoring body; and
a fastening body, wherein the fastening body is disposed in an interior of the rail body;
wherein the anchoring body is materially connected both to the fastening body and to the rail body.

19. The anchoring rail according to claim 18, wherein a common weld seam adjoins the anchoring body, the fastening body, and the rail body.

20. The anchoring rail according to claim 18, wherein the anchor rail is produced using the method according to claim 11.
